(19) United States
(12) Patent Application Publication
(10) Pub. No.: US 2003/0163450 A1
(43) Pub. Date: Aug. 28, 2003

(54) Brokering semantics between web services

(76) Inventors: Joram Borenstein, Providence, RI (US); Joshua Fox, Emek Ha'ela (IL); Zvi Schreiber, Jerusalem (IL)

Correspondence Address: James C. Scheller, Jr., BLAKELY, SOKOLOFF, TAYLOR & ZAFMAN LLP, Seventh Floor, 12400 Wilshire Boulevard, Los Angeles, CA, 90025-1026, US

(21) Appl. No.: 10/340,068

(22) Filed: Jan. 9, 2003

Related U.S. Application Data
(63) Continuation-in-part of application No. 10/302,370, filed on Nov. 22, 2002.
Application No. 10/302,370 is a continuation-in-part of application No. 10/159,516, filed on May 31, 2002.
Application No. 10/159,516 is a continuation-in-part of application No. 10/104,785, filed on Mar. 22, 2002.
Application No. 10/104,785 is a continuation-in-part of application No. 10/053,045, filed on Jan. 15, 2002.
Application No. 10/053,045 is a continuation-in-part of application No. 09/904,457, filed on Jul. 6, 2001.
Application No. 09/904,457 is a continuation-in-part of application No. 09/866,101, filed on May 25, 2001.

(51) Int. Cl. G06F 7/00

(52) U.S. Cl. 707/1

(57) ABSTRACT

Methods for brokering between services, including, in one exemplary embodiment of a method, providing a first and second service, each service having associated therewith a request and a response data structure, and generating a transformation for producing data conforming to the request data structure for the second service, corresponding to data conforming to the response data structure for the first service. Systems are also described and claimed.

### CROSS REFERENCES TO RELATED APPLICATIONS

This application is a continuation-in-part of assignee's pending application U.S. Ser. No. 10/302,370, filed on Nov. 22, 2002, entitled “Enterprise Information Unification”, which is a continuation-in-part of assignee's pending application U.S. Ser. No. 10/159,516, filed on May 31, 2002, entitled “Data Query and Location through a Central Ontology Model,” which is a continuation-in-part of application U.S. Ser. No. 10/104,785, filed on Mar. 22, 2002, entitled “Run-Time Architecture for Enterprise Integration with Transformation Generation,” which is a continuation-in-part of application U.S. Ser. No. 10/053,045, filed on Jan. 15, 2002, entitled “Method and System for Deriving a Transformation by Referring Schema to a Central Model,” which is a continuation-in-part of assignee's application U.S. Ser. No. 09/904,457 filed on Jul. 6, 2001, entitled “Instance Browser for Ontology,” which is a continuation-in-part of assignee's application U.S. Ser. No. 09/866,101 filed on May 25, 2001, entitled “Method and System for Collaborative Ontology Modeling.”

### FIELD OF THE INVENTION

The present invention relates to data modeling, and in particular to mappings between data and message schemas associated with web services and other services.

### BACKGROUND OF THE INVENTION

The web services vision of loosely coupled interaction between components, programs, and applications is already beginning to create enormous efficiencies of scale in business integration. The notion of a universal web service registry, such as Universal Description Discovery and Integration (UDDI), is helping to turn this vision into a reality. Yet despite the widespread adoption of Simple Object Access Protocol (SOAP) for XML remote procedure calls (RPC), the comprehensive adoption of a truly dynamic lookup of web services is still delayed.

Currently, the majority of web services have been developed for enterprise internal use. Most web service applications today provide highly focused functionality for solving specific business and technology problems. For these applications, where all users are within the same enterprise or project team, manual lookup and coding is sufficient.

Web Services are expected to become more widely adopted in the coming years, allowing much broader intra- and inter-enterprise integration. However, when web services are developed separately, they often rely on different terms and definitions in identifying their parameters. This causes confusion and overlap, necessitating manual intervention. As the number of web services increases, the difficulty of accessing multiple services with identical or similar names for their input and output parameters becomes increasingly difficult. Web service developers have been searching for a way to resolve this problem of semantic inconsistency.

UDDI and Web Services Description Language (WSDL) are evolving standards for specifying information resources available on the Internet. UDDI is an XML-based registry for businesses worldwide, which enables businesses to list themselves and their services on the Internet. The objective of UDDI is to streamline online transactions by enabling companies to find one another on the Web and make their systems interoperable for electronic commerce. UDDI is akin to a telephone book's white, yellow, and green pages. UDDI allows businesses to list themselves by name, product, location, or by the web services they offer. WSDL is the language used to do this. WSDL is an XML-based language used to describe the services a business offers and to provide a way for individuals and other businesses to access those services electronically.

A business registered with UDDI categorizes its web services according to a defined list of service types. Businesses can search a registry's listed service types to find service providers. UDDI represents service types using a data structure referred to as a tModel. The tModel is an abstraction for a technical specification of a service type; it organizes the service type's information and makes it accessible in the registry database.

UDDI is useful for look-up of web services, but inadequate for truly dynamic work. UDDI uses only simple taxonomies and simple hierarchical trees. UDDI is coarse-grained. WSDL can be posted to UDDI registries, and searches can be done on tModels, providing characteristics of the service as a whole, but there is no look-up on input and output parameters of web services, and in particular on their semantics.

When implementing large-scale heterogeneous UDDI-based web service installations, difficulties often arise due to semantic confusion. As the number of web services increases, the difficulty of accessing multiple services with weakly defined semantics for their input and output parameters and for their functionality becomes increasingly difficult. Semantic inconsistency arises substantially from three sources:

1. poorly-defined semantics;

2. similar syntax, different semantics; and

3. different syntax, similar semantics.

Poorly defined semantics are a main source of semantic inconsistency. Web services are meant to describe the individual workings of a program or a component. Typically, however, service semantics are often left unstated and are guessed at or interchanged by humans. Web services are meant to describe the individual workings of a program or a component. Without sufficient description, a service is virtually useless to anyone but the original developer.

Consider, for example, a tax calculation web service, which has a single, synchronous operation. This operation receives an input message with floating-point “amount” and string “zip,” and an output message with floatingpoint “rate” and integer “tax.” Reference is now made to FIG. 1, which is a prior art block diagram of the above referenced tax calculation web service. Reference is also made to Appendix A, which is a prior art listing of a WSDL document corresponding to the web service of FIG. 1.

Although this example is a simple web service, yet confusion arises without a formal specification of semantics. For example, what units go into the “amount” parameter? It happens to be U.S. dollars. That might be obvious to a service provider who intended this service for U.S. consumption, but in a world wide web, potential service clients may come to it from any geographical location.

The second form of semantic inconsistency derives from a situation in which two services share a similar syntax but have different semantics. Such a situation typically results in users discovering that an outcome is different than anticipated. Unspecified difference in semantics can cause confusion between different services. This causes problems when a client is coded to use one service, but tries to use another service with different semantics. As long as the syntax, as represented, for example, by WSDL message definitions, is the same for both services, the call to the other service will succeed, but the service returns unexpected results.

Two tax calculation services, for example, may receive similar inputs and respond with similar outputs, but one calculates income tax while the other calculates sales tax. A client must be aware of the precise functionality a web service provides before calling it. Even where WSDL is available, semantics are not expressed precisely in the service interface alone, but must be learned by the developer working on the client side.

A third form of semantic confusion occurs with two web services having similar semantics and different syntax. Two services, for example, may calculate sales tax, and have the interface described hereinabove, but in the first service, “rate” is a multiplier; i.e., a 5½% rate would be given as 0.55, while in the other, it is a percentage; i.e., the same value would be given as 5.5%. Multiplier and percentage are semantically identical, as long as a factor of a 100 can be taken into account in transforming one to the other.

Likewise, the “zip” parameter, which allows tax to be calculated based on the legal jurisdiction, is a five-digit U.S. Postal Service zip code in one service. Yet a client application may have been coded to work with another service, one that has the same functionality, but expects a nine-digit zip code. Clearly the shorter zip code may be derived from the longer zip code by truncation, but software does not know this unless it is formally coded.

Where services have similar functionality but different syntax, it is often easy to convert between the two, but only if the meaning of each input and output parameter is understood precisely.

The quandaries of semantic inconsistency are challenging and highly problematic. Failure to address them with a universal look-up and discovery mechanism will hinder, or possible even sidetrack Web Service adoption.

Solving the problems of semantic inconsistency requires a semantic approach to the dynamic discovery and interoperability of web services. However, semantics are not easily expressed in WSDL or UDDI. Fundamentally, UDDI and WSDL are syntactical rather than semantic. They express protocols and data formats, but do not formally encode the full meanings of each service. Similar technologies, such as Electronic Business Extensible markup Language (ebXML), suffer from the same inadequacy.

To locate a desired web service, what is needed is an expression of a web services' “meaning.” The WSDL interface encodes expected input and output, but this syntactic structure is insufficient. Although WSDL interfaces can be attached to UDDI tModels, it is difficult to express the semantics of web services or of individual WSDL parameters.

The dream of “just-in-time integration” has not yet been realized. The most common approach to look-up remains the manual exchange of information between developers in different enterprises—which is not scalable and does not allow for a dynamic exchange of services. Such shortcomings slow the rate of adoption among users and threaten the comprehensive use of UDDI registries in the future.

### SUMMARY OF THE INVENTION

The present invention enables dynamic web service integration by overcoming problems of semantic inconsistency. The present invention provides a semantic model for web services, based on an ontology model. The present invention embeds a fine-grained description of meaning for UDDI taxonomies and WSDL interfaces in an ontology; namely, a formal semantic model that provides a shared vocabulary for describing real-world entities and relationships therebetween explicitly. When input and output messages in WSDL are linked to an ontology, data processing systems, such as computers executing server and client software can automatically resolve semantic ambiguities among web services that have similar or overlapping meaning. With such a semantic layer, dynamic lookup and truly automated interoperability of web services becomes possible.

Using the present invention, UDDI taxonomies and WSDL interfaces are mapped into ontological models. The ontological models enable look-up by semantic values. Using the present invention, a query expresses the semantics of a desired service and is phrased in terms of ontological classes and in terms of their properties. In response, appropriate web services are dynamically discovered, along with their interfaces and bindings.

UDDI and WSDL relate interactions to distinct roles, including service provider, registry, and client. In a preferred embodiment, the present invention requires no change to a registry, and allows publicly available replicated UDDI networks to be used. The semantic approach to service discovery of the present invention likewise relates to roles for service provider and client. In a preferred embodiment of the present invention, a service provider has a burden of providing detailed information about the meaning of the service; however, the client has to ensure that a service can be discovered semantically.

It may be appreciated by those skilled in the art that implementation of the present invention preferably does not require additional stages in a development process, as such stages must in any case be done, albeit informally, in spreadsheets or word-processor documents. For a service to be used, a provider must tell a client what the service “means,” and the client must understand what it means. The semantic discovery procedure of the present invention simply requires that this be done formally.

Thus it may be appreciated that the present invention provides a new type of registry; namely, a “semantic registry.” Semantic registries go beyond conventional registries and enable the vision of web services; namely, the seamless interaction of software through the exchange of formalized service semantics.

UDDI alone cannot deliver the vision of loosely coupled dynamically interoperating web services, and cannot ensure that the current growth in web services adoption will continue. Without a semantic infrastructure to form the backbone of the UDDI registry, semantic inconsistency will prevent the large-scale adoption of active web services lookup. The ongoing decentralization of web services will make this problem increasingly acute in the coming few years.

Using the present invention, a semantic infrastructure backing the registry is used to dynamically discover services by meaning. The present invention enables zero-intervention web service networks, achieved by semantic look-up.

There is thus provided in accordance with a preferred embodiment of the present invention a method for brokering between services, including providing a first and second service, each service having associated therewith a request and a response data structure, and generating a transformation for producing data conforming to the request data structure for the second service, corresponding to data conforming to the response data structure for the first service.

There is moreover provided in accordance with a preferred embodiment of the present invention a method for developing applications including connecting designators for a first and second service within a layout diagram, each service having associated therewith a request and a response data structure, and generating a transformation for producing data conforming to the request data structure for the second service, corresponding to data conforming to the response data structure for the first service.

There is additionally provided in accordance with a preferred embodiment of the present invention a method for developing applications including identifying connected designators for a first and second service within a layout diagram, each service having associated therewith a request and a response data structure, and generating a transformation for producing data conforming to the request data structure for the second service, corresponding to data conforming to the response data structure for the first service.

There is further provided in accordance with a preferred embodiment of the present invention a method for registering services, including specifying at least one service having associated therewith at least one input and output data structure, and mapping the at least one input and output structure into a common ontology model.

There is yet further provided in accordance with a preferred embodiment of the present invention a method for providing semantic meaning to Java beans, including providing a plurality of Java beans, each Java bean having associated therewith a data structure, and mapping the data structures of the plurality of Java beans into a common ontology model.

There is moreover provided in accordance with a preferred embodiment of the present invention a system for brokering between services, including an interface for executing a first and second service, each service having associated therewith a request and a response data structure, and a transformation generator for generating a transformation for producing data conforming to the request data structure for the second service, corresponding to data conforming to the response data structure for the first service.

There is additionally provided in accordance with a preferred embodiment of the present invention a system for developing applications including a design tool for connecting designators for a first and second service within a layout diagram, each service having associated therewith a request and a response data structure, and a transformation generator for generating a transformation for producing data conforming to the request data structure for the second service, corresponding to data conforming to the response data structure for the first service.

There is further provided in accordance with a preferred embodiment of the present invention a system for developing applications including a layout analyzer for identifying connected designators for a first and second service within a layout diagram, each service having associated therewith a request and a response data structure, and a transformation generator for generating a transformation for producing data conforming to the request data structure for the second service, corresponding to data conforming to the response data structure for the first service.

There is yet further provided in accordance with a preferred embodiment of the present invention a system for registering services, including specifying at least one service having associated therewith at least one request and response data structure, and a data schema mapper for mapping the at least one request and response structure into a common ontology model.

There is moreover provided in accordance with a preferred embodiment of the present invention a system for providing semantic meaning to Java beans, including a Java bean analyzer for analyzing a plurality of Java beans, each Java bean having associated therewith a data structure, and a data schema mapper for mapping the data structures of the plurality of Java beans into a common ontology model.

There is additionally provided in accordance with a preferred embodiment of the present invention a method for providing semantic meaning to web services descriptions, including providing a plurality of web services, each web service having associated therewith a request and a response data structure, and mapping the request and response data structures of the plurality of web services into a common ontology model.

There is further provided in accordance with a preferred embodiment of the present invention a system for providing semantic meaning to web services descriptions, including a web services analyzer for analyzing a plurality of web services, each web service having associated therewith a request and a response data structure, and a data schema mapper for mapping the request and response data structures of the plurality of web services into a common ontology model.

### BRIEF DESCRIPTION OF THE DRAWINGS

The present invention will be more fully understood and appreciated from the following detailed description, taken in conjunction with the drawings in which:

FIG. 1 is a prior art block diagram of an example web service;

FIG. 2 is a simplified block diagram of a transformer, which generates a semantic match between the response of a first service and the request of a second service, in accordance with a preferred embodiment of the present invention;

FIG. 3 is a simplified block diagram of matching responses from three services that feed into requests for two services, in accordance with a preferred embodiment of the present invention;

FIG. 4 is a simplified flow chart of a semantic registration process performed by a service provider, in accordance with a preferred embodiment of the present invention;

FIG. 5 is a simplified graph for a semantic model corresponding to a web service, in accordance with a preferred embodiment of the present invention;

FIG. 6 is a simplified illustration of a mapping between the semantic model of FIG. 4 and the above WSDL schema, in accordance with a preferred embodiment of the present invention;

FIG. 7 is a simplified block diagram of saving a model, a WSDL document, and mappings between the WSDL interface and the model, to a UDDI registry, in accordance with a preferred embodiment of the present invention;

FIG. 8 is a simplified flow chart of a semantic discovery process performed by a client who needs to discover a service that meets his required business needs, in accordance with a preferred embodiment of the present invention;

FIG. 9 is a simplified flow chart for the use of transformations to adapt a software application that is coded for a first WSDL document so as to operate with a second WSDL document, in accordance with a preferred embodiment of the present invention;

FIG. 10 is a simplified block diagram of a system that adapt a software application that is coded for a first WSDL document so as to operate with a second WSDL document, in accordance with a preferred embodiment of the present invention; and

FIG. 11 is a sample user interface window, in accordance with a preferred embodiment of the present invention.

### LIST OF APPENDICES

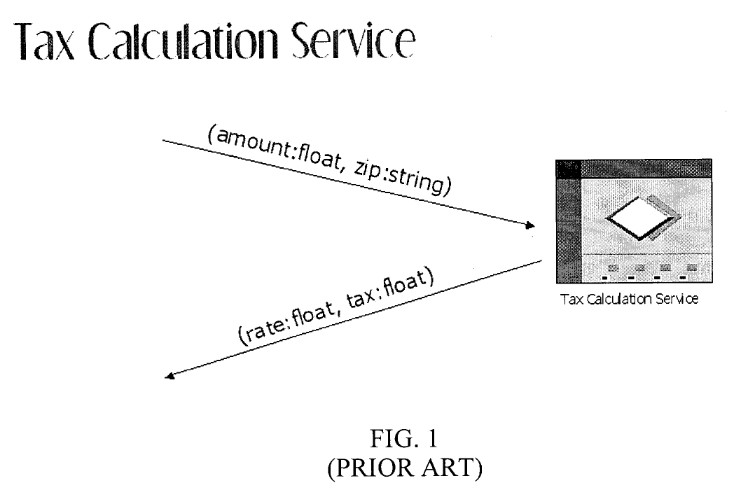

Appendix A is a prior art listing of a WSDL document corresponding to the web service of FIG. 1; and

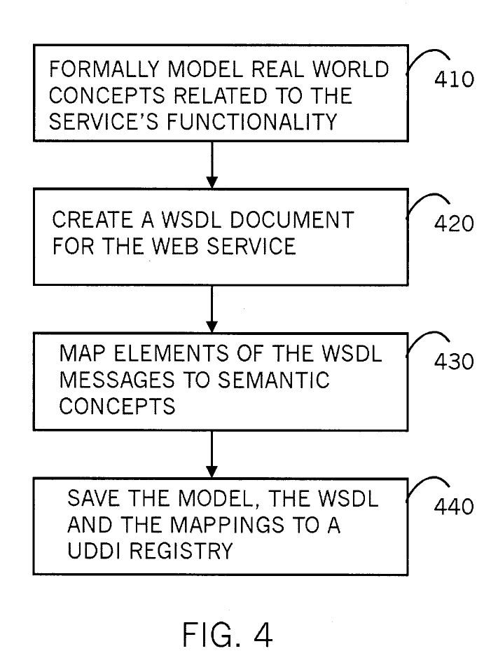

Appendix B is a listing of an exemplary XML document for an ontology model corresponding to the semantic model of FIG. 4, in accordance with a preferred embodiment of the present invention.

### DETAILED DESCRIPTION OF A PREFERRED EMBODIMENT

The present invention concerns a method and system for providing a semantic registry for web services and other services. The phrase “present invention” as used herein, means at least one exemplary embodiment which is described in this disclosure and does not mean that any of the claims are to be limited to that particular embodiment.

The present invention provides a semantic model for web services, based on an ontology model. As described hereinbelow, an ontology model is a formal semantic model having a richer expressiveness than the taxonomic information models of UDDI and ebXML. An ontology model includes inheritance, relationships, built-in business rules, and dynamic linkage between compatible but independent user-defined models, which are useful for software to understand how to communicate with a web service without human intervention. Further, with the assistance of WSDL documents, an ontology model presents a finer grain of detail, specifying the meanings of input and output messages.

The present invention embeds a fine-grained description of meaning for UDDI taxonomies and WSDL interfaces in an ontology model, which provides a shared vocabulary for describing real-world entities and the relationships therebetween explicitly. Once input and output messages in the WSDL are linked to an ontology model, server and client software can automatically resolve semantic ambiguities among web services that have similar or overlapping meaning. With this semantic layer, dynamic lookup and truly automated interoperability of web services becomes possible.

Using the present invention, UDDI taxonomies and WSDL interfaces are mapped into ontological models. In a preferred embodiment of the present invention, tModels are mapped to corresponding ontological classes, thereby providing semantics to the tModels. Moreover, ontological properties and inheritance add expressive power. Similarly, in a preferred embodiment of the present invention, WSDL interfaces are mapped to corresponding ontological classes, and their parameters are mapped to corresponding ontological properties.

The ontological model enables look-up by semantic values. Using the present invention, a query expresses the semantics of a desired service, and is phrased in terms of ontological classes and their properties. In response, by using the mappings to the tModels and WSDL messages, appropriate web services are dynamically discovered, along with their interfaces and bindings.

Thus it may be appreciated that the present invention provides a new type of registry; namely, a “semantic registry.” Semantic registries go beyond conventional registries and enable the vision of web services; namely, the seamless interaction of software through the exchange of formalized service semantics.

In a preferred embodiment of the present invention, Java API for XML resources (JAXR) is extended to provide semantic translation services for web service interoperability. JAXR provides a Java interface to web service registries, and thereby provides flexibility to build implementations for heterogeneous web service repositories.

Using the present invention, Java architects and developers can create environments in which web services with disparate interfaces are able to find each other using JAXR registries and leverage semantics to successfully interoperate. The extensible architecture of JAXR supports the present invention by layering a plug-able provider on top of registry-specific JAXR providers. In this way, a semantic registry is built, either as a front-end for existing semantic repositories, or as a bridge provider adding semantic content to an existing repository framework. It may thus be appreciated that, in a preferred embodiment, the semantic registry implementation of the present invention leverages flexibility of the JAXR API and adds the power of semantic queries to the JAXR API.

It will be appreciated that the various methods and services of the present invention may be implemented by data processing systems, such as client computer systems or server computer systems. A computer system is generally any system (e.g. general purpose desktop computer, or handheld computer or PDA (personal digital assistant) or cell phone (e.g. web enabled cell phone)) which includes a processor and memory which stores software instructions (e.g. the software referred to in this disclosure) which can be executed by the processor. Generally, two such data processing systems which interact with each other (e.g. client and server systems) communicate through a network, such as the Internet. See U.S. Pat. No. 6,222,549 for examples of computer systems and networks. It will also be appreciated that the information and data structures which are described in this disclosure may be stored in the physical memory (e.g. RAM or non-volatile storage) of such computer systems.

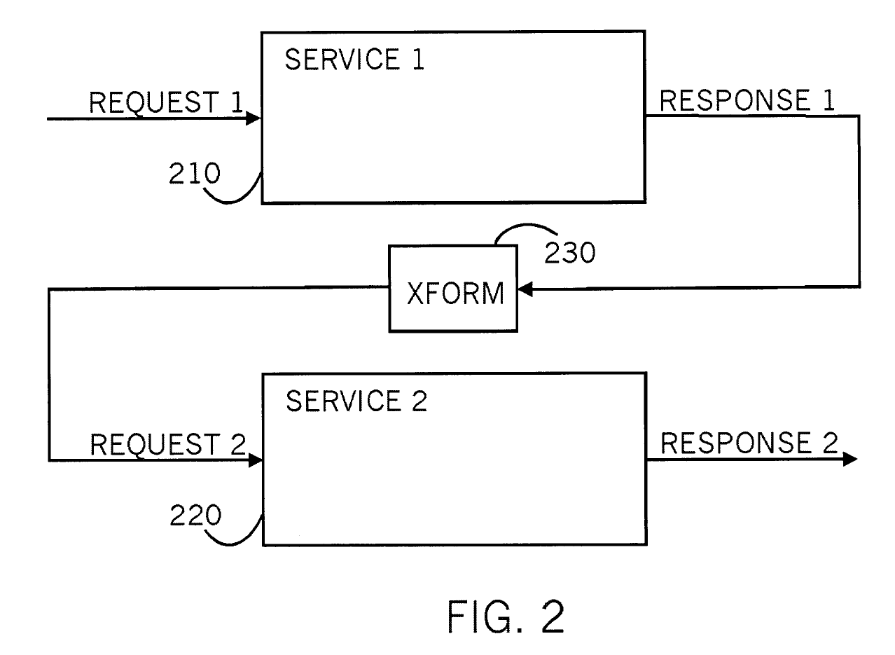

Reference is now made to FIG. 2, which is a simplified block diagram of a transformer, which generates a semantic match between the response of a first service and the request of a second service, in accordance with a preferred embodiment of the present invention. Shown in FIG. 2 are a first service 210, which operates by accepting an input, such as a request message, and producing an output, such as a response message; and a second service 220, which similarly operates by accepting a request and producing a response therefrom.

A comprehensive semantic infrastructure can ensure consistent semantics across web services. In a preferred embodiment of the present invention, data structures for the requests and responses of each of service 210 and service 220 are mapped into a common ontology model, through which the data in requests and responses can be given semantic meaning.

Ontologies are formal and highly expressive data reference models that compose a key layer in a semantic infrastructure. Because of the richness of ontological models, they have attracted attention and generated interest in the last decade.

Ontologies come from the world of philosophy where they mean a study of what exists, and have been adopted by computer science in the 1980s and the 1990s, particularly by those interested in artificial intelligence. An ontology model is composed of classes, properties, and business rules.

Classes are sets, the elements of which are referred to as instances of the class. A property, p, of a class is a function p: C→D from a class C, referred to as the source of p, to a class D, referred to as the target of p. The classes C and D may be the same class or different classes. When it is important to distinguish between properties defined on different classes, the longer notation C.p is also used to denote a property, p, defined on C.

An example of a class is Automobile. A property for such a class is weightOf. A business rule for this property is totalWeight=bodyWeight+engineWeight.

Properties may be composed, so that if p: C→D and q: D→E, then the composition q∘p: C→E has source C and target E. The composition is also denoted by the longer notation C.p.q.

Ontologies enable rich expression through the use of a concept taken from the world of object-oriented programming; namely, inheritance, which allows the world to be viewed at different levels of resolution from general concept to one or more ways of specializing.

Inheritance allows subclass and superclass relationships. A subclass, or “child” class, inherits properties of its superclass, or “parent” class. Subclasses can have additional subclasses, enabling the creation of increasingly specialized information.

A class C is said to be a subclass of D if C⊂D, in which case D is also said to be a superclass of C. In this case, every instance of C is also an instance of D, and properties defined on D can be defined on C by inheritance. For example, a class named Passengers may be a subclass of a class named People. A property such as firstName, defined on People is inherited by Passengers.

Certain properties, referred to as representations, take on concrete fundamental alphanumeric values. The significance of representations is that they are properties one can reason about using arithmetic, logical and string operators, since their type corresponds to types of mathematical expressions and programming language expressions.

Properties of an ontology class may be inter-related, and such relationships can be modeled using business rules. Business rules are used inter alia to specify that one property is an inverse of another, or that one property can be expressed in terms of other properties using a look-up table, formula or algorithm.

Packages are preferably used to organize and group related classes together in a way that is convenient for a user. Packages are not necessarily indicative of any particular formal description within the ontology.

Ontologies are currently being standardized by the W3C's Web Ontology Working Group, the objective of which is to form a unified Ontology Web Language (OWL) to allow for the interchange and merging of ontologies.

Ontologies are particularly relevant for web services. They can be used to distinguish between overlapping semantics, to overcome confusion, and to clearly delineate services' offerings. An ontology model reflects an agreed upon view of real world objects to which the services relate, thus providing an objective reference vocabulary that can give common meaning to services using different syntaxes.

Referring back to FIG. 2, data structures for the requests and responses of services 210 and 220 are “mapped” into a common ontology model through mappings that identify a correspondence between data constructs of the requests and responses and between data constructs of the ontology, including inter alia classes, properties and combinations of properties. “Mapping” is a process of rationalizing and harmonizing one set of information with another. Many ontology models have been created as a result of mapping.

The UDDI registry and framework are built on taxonomies. UDDI taxonomies are simple hierarchical structures and are limited in their descriptive capabilities. As UDDI continues to become larger and more comprehensive, its lack of semantics is a barrier of entry into industry, since it limits UDDI's ability to enable true dynamic interoperability.

WSDL is used to describe a web service, specify the service's location, and the operations, or methods, that the service exposes. WSDL encodes expected input and output. However, but the WSDL “syntactic structure” is insufficient to overcome semantic inconsistency. Although WSDL interfaces can be attached to UDDI tModels, it is difficult to express semantics of web services or of individual WSDL parameters through WSDL.

The shortcomings of UDDI and WSDL are preferably overcome by mapping UDDI taxonomies and WSDL interfaces to ontological models, as described hereinbelow. Once an agreed-upon vocabulary is captured within an ontology model, each taxonomy and interface may be correlated to a requisite portion, resulting in clear description and focus for web services.

tModels are a UDDI data structure that describe shared design, individual concepts, or specifications for services or taxonomies. Individual tModels are assigned a unique key once they are registered with the UDDI registry. UDDI tModels were originally designed to overcome a multitude of standards in he e-commerce marketplaces, and to obviate the need to conform to individual consortia specifications.

In a preferred embodiment of the present invention, UDDI tModels are used to map UDDI taxonomies to ontological models. Preferably, tModels are mapped to ontological classes, each of which is stored in a package. Properties, constraints, and inheritance relationships provide additional expressive power for describing each tModel in a fine-grained manner.

WSDL is also conveniently mapped to ontological model, to thus provide comprehensive description, using individual WSDL interfaces. WSDL service interface definitions, referred to herein as WSDL interfaces, describe numerous service instances. They are registered as UDDI tModels, with each tModel classified by using a uddi-org:types taxonomy.

In a preferred embodiment of the present invention a WSDL interface is mapped to one or more classes in an ontological model. The WSDL parameters, also referred to as “bindings,” are mapped to properties in the ontology model.

When individual UDDI tModels and WSDL interfaces are mapped to an ontological model, semantic lookup and querying is enabled. The ontological model preferably assists in lookup by semantic values to be searched. In a preferred embodiment of the present invention, a query asks for one or more ontological classes and properties expressing semantics of a desired web service. By using the mappings of the tModels and the WSDL interfaces an ontological query processor dynamically discovers appropriate web services, including interface and bindings.

In addition to providing semantic query capabilities, the present invention enables web services developers to benefit from consensus. An agreed-upon vocabulary distinguishing web services' syntaxes and semantics eliminates inconsistencies and provides for clear and easy usage. Fine-grained description of meaning for UDDI taxonomies and WSDL interfaces are embedded within an ontology model. Relationships between web services and descriptions of web services are expressed formally and explicitly. When input and output messages in a WSDL document are linked to an ontology model, server and client software can automatically resolve semantic ambiguities among web services that have similar or overlapping meaning. With such a semantic layer, dynamic lookup and automated interoperability of web services is possible.

Referring back to FIG. 2, when data structures are mapped into a common ontology model, transformations between the data structures are dynamically generated, on the fly. Transformation 230, from the response data structure of service 210 to the request data structure of service 220, is such a transformation.

Generation of transformations is described in applicant's six co-pending patent applications:

1. U.S. Ser. No. 09/866,101, filed on May 25, 2001 and entitled “Method and System for Collaborative Ontology Modeling;”

2. U.S. Ser. No. 09/904,457, filed on Jul. 6, 2001 and entitled “Instance Browser for Ontology;”

3. U.S. Ser. No. 10/053,045, filed on Jan. 15, 2002 and entitled “Method and System for Deriving a Transformation by Referring Schema to a Central Model;”

4. U.S. Ser. No. 10/104,785, filed on Mar. 22, 2002 and entitled “Run-Time Architecture for Enterprise Integration with Transformation Generation;”

5. U.S. Ser. No. 10/159,516, filed on May 31, 2002 and entitled “Data Query and Location through a Central Ontology Model;” and

6. U.S. Ser. No. 10/302,370, filed on Nov. 22, 2002 and entitled “Enterprise Information Unification,”

the contents all of which are hereby incorporated by reference. As described in the above-referenced applications, for relational database structures the transformations preferably take the form of SQL queries, and for XML data structures the transformations preferably take the form of XSLT transformations. In a preferred embodiment of the present invention, transformations are expressed in programming languages, including inter alia Java, C++, Visual Basic, Perl, Python, Smalltalk, Delphi and C#.

Thus it may be appreciated that the present invention can be used to provide a service, which itself acts as a broker between other services. Specifically, in a preferred embodiment of the present invention, generation of transformation 230 is performed by a service embodying the present invention. Such a service preferably also executes transformation 230 in order to broker between services 210 and 220.

It may be appreciated by those skilled in the art that services 210 and 220 are general request-response oriented services, preferably associated with enterprise information systems. Such services include inter alia web services, remote procedure call (RPC) services, remote function call (RFC) services and remote method invocation (RMI) services. For RFC services, requests and responses are typically passed as function parameters. RFC services include inter alia Common Object Request Broker Architecture (CORBA) systems, and Distributed Component Object Model (DCOM) systems. RMI services include Enterprise Java Beans (EJB) systems.

It may be appreciated by those skilled in the art that services 210 and 220 may also be local function calls. Indeed, developers often integrate disparate APIs for local use; e.g., when integrating to software libraries such as dynamic link libraries (DLLs) with Windows, and jar libraries with Java.

Accordingly, the request and response data structures may take a variety of forms. Thus for web services, requests and responses are typically passed within messages formatted according to a Web Services Description Language (WSDL) standard, or according to a Universal Description Discovery and Integration (UDDI) registry standard, or according to an Electronic Business Extensible Markup Language (ebXML) registry standard. For CORBA systems, requests and responses are typically formatted according to an Interactive Data Language (IDL) standard. For RMI systems, requests and responses are typically formatted according to a Java interface. For DCOM systems, requests and responses are typically formatted according to a Microsoft Interface Definition Language (MIDL).

It may be appreciated by those skilled in the art that the components illustrated in FIG. 2 typically are part of a larger system including a multitude of inter-connected service components. For each connection between services, the present invention preferably is used to generate an appropriate transformation so as to glue together responses from one or more services that feed into a request for another service.

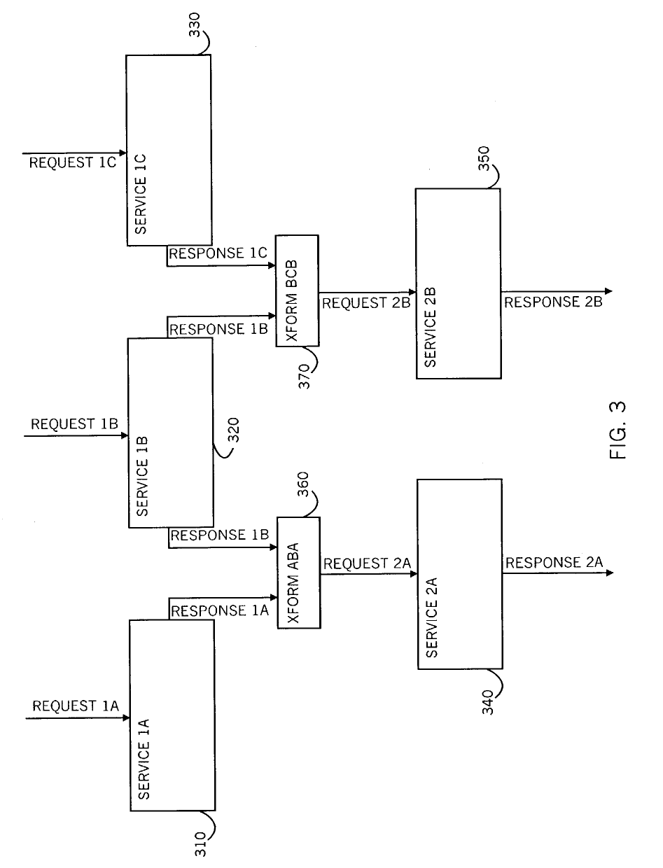

Reference is now made to FIG. 3, which illustrates matching responses from three services that feed into requests for two services, in accordance with a preferred embodiment of the present invention. Specifically, responses from services 310 and 320 feed into a request for service 340, and responses from services 320 and 330 feed into a request for service 350. Using the present invention, transformations are dynamically generated to match up the appropriate responses with the appropriate requests. Specifically, transformation 360 generates a request data structure for service 340 from the response data structures from services 310 and 320, and transformation 370 generates a request data structure for service 350 from the response data structures from services 320 and 330.

It may be appreciated from FIG. 3 that the present invention is useful in a variety of application development systems. In a preferred embodiment of the present invention, a developer of a web application uses a visual layout tool to inter-connect visual controls for web services, and the present invention automatically generates the transformations necessary to adhere to each request data structure at each feed into each web service. Preferably, as described hereinabove, the request and response data structures of each web service are mapped into a common ontology model. The present invention identifies each inter-connection in a web application layout, and, using the mappings of the data structures feeding in and out of each connection, automatically generates an appropriate transformation to match up the web service semantics.

The semantic approach to service discovery of the present invention preferably relates to roles for service provider and client. In a preferred embodiment of the present invention, a service provider has a burden of providing detailed information about the meaning of the service; however, the client has to ensure that a service can be discovered semantically.

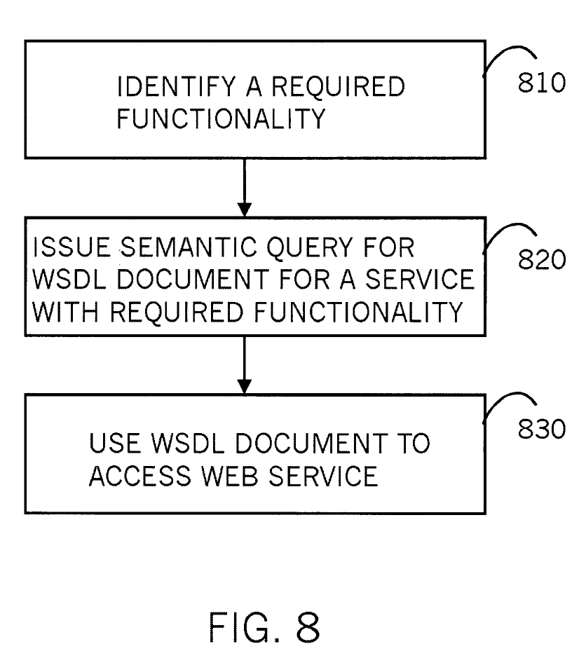

It may be appreciated by those skilled in the art that implementation of the present invention preferably does not require additional stages in a development process, as such stages must in any case be done, albeit informally, in spreadsheets or word-processor documents. For a service to be used, a provider must tell a client what the service “means,” and the client must understand what it means. The semantic discovery procedure of the present invention simply requires that this be done formally, as described hereinbelow with reference to FIGS. 4 and 8.

Reference is now made to FIG. 4, which is a simplified flow chart of a semantic registration process performed by a service provider, in accordance with a preferred embodiment of the present invention. At step 410 the service provider formally models real world concepts related to the service's functionality. Specifically, for a service provider, allowing semantically based interactions starts with defining an ontology for the real-world domain of a service. The provider creates a “semantic model” of real life logic underlying the service. Such a model is preferably based on principles of ontology models, conceptual constructs representing the science of meaning.

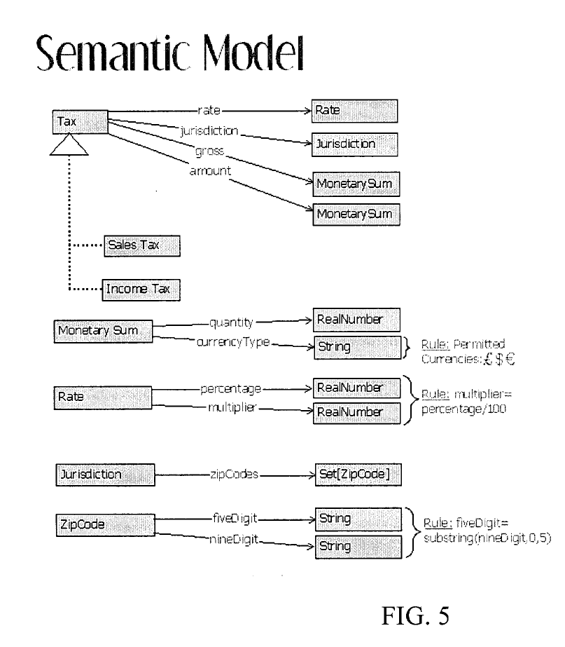

Reference is now made to FIG. 5, which is a simplified graph for a semantic model corresponding to the tax calculation example service mentioned hereinabove, in accordance with a preferred embodiment of the present invention.

The semantic model is an abstract structure that can be exchanged in Web Ontology Language (OWL), the W3C XML-based standard for representing ontological models. The semantic model can be saved to a standard UDDI registry as a tModel, as described hereinbelow.

The semantic model represents the “meaning” of a service's functionality. It does not matter if the service works with dollars or euros, percentages or multipliers. Once these notions are encoded, semantic software preferably transforms one XML data document to another, to make these differences transparent. The software's functionality determines the meanings of input and output.

Reference is now made to Appendix B, which is a listing of an exemplary XML document for an ontology model corresponding to the semantic model of FIG. 5, in accordance with a preferred embodiment of the present invention. The XML document in Appendix B conforms to an XML schema for ontologies.

After step 410, the semantic model does not yet represent the service itself, since specific input and output parameters are not encoded. However, it does represent critical concepts needed to understand the service's functionality

At step 420 the service provider creates a WSDL document for the service. Preferably, the provider formally specifies the WSDL, the structure of input and output messages, and other aspects of the service's run-time bindings

At step 430 the service provider maps elements of the WSDL messages to semantic concepts. At this step, the provider preferably expresses the meaning of the WSDL by mapping schemas of the WSDL input and output messages to the ontology.

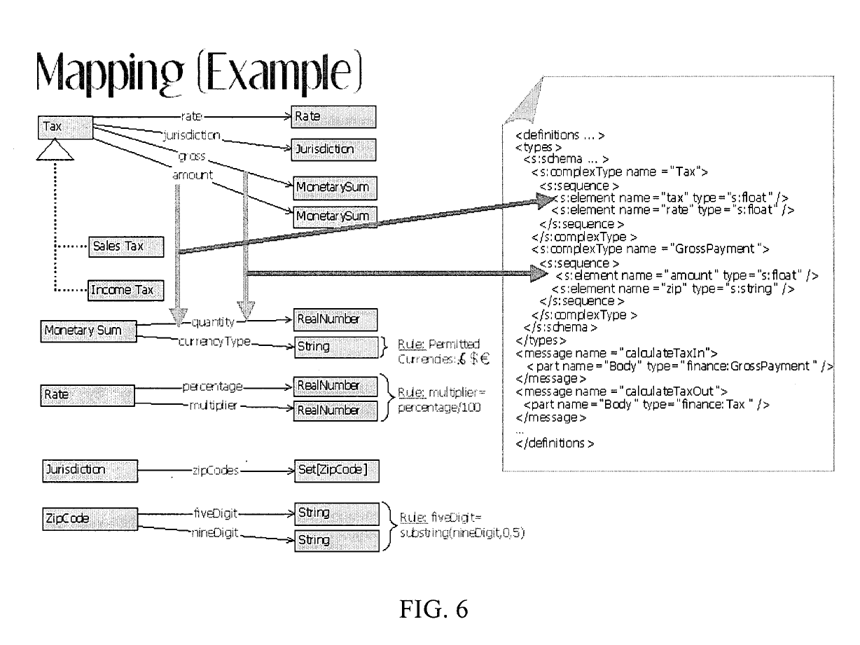

Reference is now made to FIG. 6, which is a simplified illustration of a mapping between the semantic model of FIG. 5 and the above WSDL schema, in accordance with a preferred embodiment of the present invention. For example, the “rate” in the WSDL output structure, namely, the element “rate” in the complexType “Tax,” is mapped to the rate property of class Tax.rate.multiplier, concatenated with property multiplier of class Rate; i.e., to the composed property Tax.rate.multiplier. In this way, the precise meaning of this output parameter is encoded. A client that is looking for a percentage can easily transform multiplier to percentage, by using a business rule formally encoded in the semantic model, multiplier=percentage/100. Likewise, the 5-digit zip code, namely, the element “zip” in the complexType “GrossPayment,” is mapped to the jurisdiction property of class Tax, as extended by the 5-digit property of class ZipCode.

At step 440, the provider saves the semantic model, the WSDL and the mappings to a UDDI registry, for client access.

It is noted that WSDL allows SOAP input and output to be specified in two different ways; namely, either as literal values, expressed with XSD schemas, or encoded as function parameters. In the first way; i.e., the literal approach, XML documents are passed. The second way; i.e., the encoded approach, resembles function calls as typically used in programming languages. It may be appreciated by those skilled in the art that although the present description uses the literal approach, the present invention adapts to the encoded approach as well.

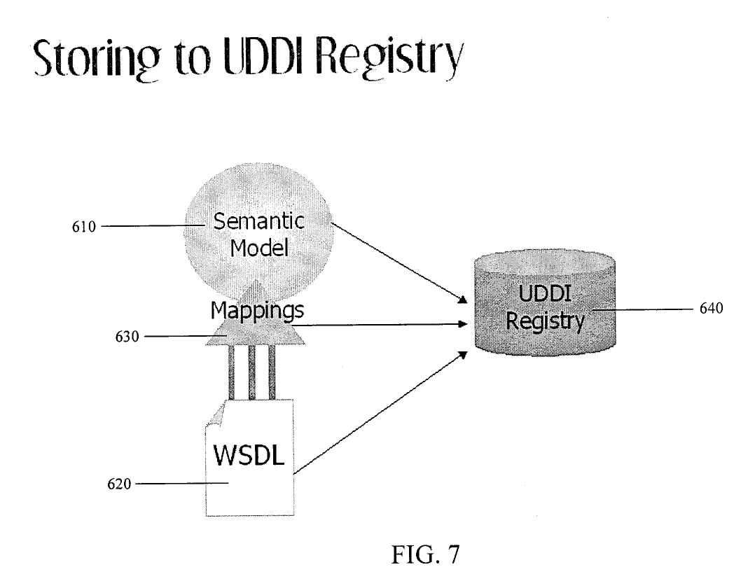

Reference is now made to FIG. 7, which is a simplified block diagram of saving a model 710, a WSDL document 720, and mappings 730 between the WSDL interface and the model, to a UDDI registry 740, in accordance with a preferred embodiment of the present invention.

It is noted that concepts in the WSDL, the semantic model, and the mappings between them fit naturally into the UDDI information model. Specifically, an XML document for the semantic model is saved as a tModel in the UDDI registry. The WSDL is also saved to the registry as a tModel, which is standard practice for using WSDL in a repository context. Likewise, the mappings between the WSDL elements and the ontological concepts are stored in an XML document. A useful XML standard for storing relationships between concepts is the Resource Description Framework (RDF) standard.

The present invention typically requires saving more artifacts to a registry than the conventional non-semantic approach. Fortunately, however, the UDDI information model is flexible enough to allow this sort of usage. It is noted that the UDDI API supports batch-processing capabilities, allowing the saving or querying of multiple tModels with a single remote call.

After completion of step 440, the web service is ready for semantic discovery.

Reference is now made to FIG. 8, which is a simplified flow chart of a semantic discovery process performed by a client who needs to discover a service that meets his required business needs, in accordance with a preferred embodiment of the present invention. At step 810 the client identifies a required functionality. Preferably, the client first accesses an agreed-upon semantic model using UDDI. The techniques to do so resemble use of UDDI for accessing other resources; namely, the client locates an XML document representing the semantic model by finding an appropriate tModel, based on industry sector and general taxonomies.

The semantic model is general enough to cover a wide variety of services for the given industry sector. For example, the model depicted in FIG. 5 would typically be part of a larger industry-standard model for financial services. Where multiple “standard” models exist, they can easily be linked together by ontological properties and inheritance to form a larger, more inclusive model.

In the conventional non-semantic approach, industry definitions and taxonomies form a type of semantics. However, beyond that the client must know exactly what service is needed and exactly what input and output messages to search for in the registry. In the semantic approach of the present invention, the client need only identify the functionality of a service in terms of input and output concepts, as expressed in meaningful semantic classes such as SalesTax, ZipCode, and TaxRate.

At step 820, the client issues a semantic query for a WSDL document for a service with desired functionality. Having identified relevant semantic concepts in the model at hand, the client can navigate mappings that link the model to the desired WSDL files. The client thus discovers a WSDL file with a function whose input and output schemas are mapped to the input and output model concepts.

Referring back to the tax calculation example service, a WSDL whose input schema includes elements mapped to ontological properties amount and zip and whose output schema includes elements mapped to ontological properties tax and rate is a suitable web service.

At step 830, the client uses the WSDL to access the web service. With a WSDL document available to fully characterize the Web Service, the client can call on the web service directly.

Once the client has discovered a sought after WSDL, a developer can manually write software to use it. Alternatively, in a preferred embodiment, the present invention may be used to automatically adapt software coded to use a different WSDL, say, WSDL #1, so as to be able to use the WSDL discovered at step 620, say, WSDL #2. Specifically, the present invention automatically generates a transformation to transform the input of WSDL #1 into the input of WSDL #2, and a transformation to transform the output of WSDL #2 into the output of WSDL #1. Such transformations enable existing software that operates with WSDL #1, to automatically process input and output for WSDL #2, without the need for manual software development.

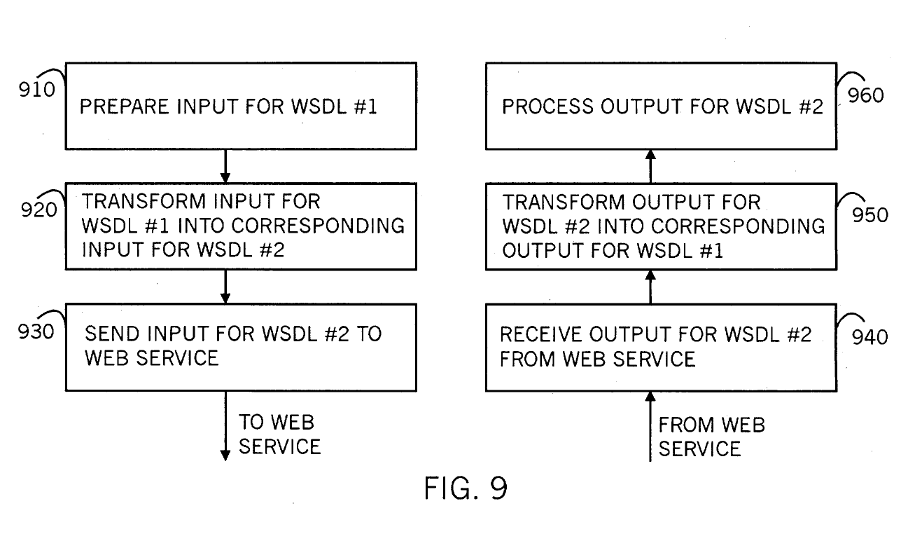

Reference is now made to FIG. 9, which is a simplified flow chart for the use of transformations to adapt a software application that is coded for a first WSDL document so as to operate with a second WSDL document, in accordance with a preferred embodiment of the present invention. At step 910 a software application that is coded to use a web service corresponding to a first WSDL document, WSDL #1, prepares input conforming to WSDL #1. At step 920 a transformation is used to transform input conforming to WSDL #1 to corresponding input conforming to a second WSDL document, WSDL #2, for use with a web service corresponding to WSDL #2. The web service corresponding to WSDL #2 may be an update version of the web service corresponding to WSDL #1, or it may be a different service altogether.

At step 930 the input conforming to WSDL #2 is sent to a web service, which processes the input to derive an output therefrom. At step 940 the output from the web service, which conforms to WSDL #2, is sent back to the software application. At step 950 the output conforming to WSDL #2 is transformed to corresponding output conforming to WSDL #1. Finally, at step 960 the output conforming to WSDL #1 is used by the software application, as expected.

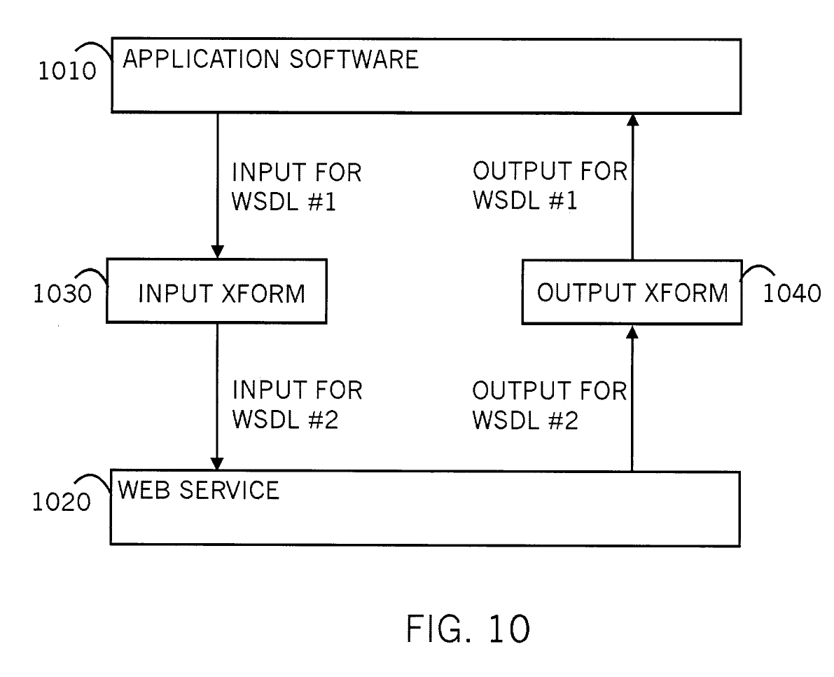

Reference is now made to FIG. 10, which is a simplified block diagram of a system that adapt a software application that is coded for a first WSDL document so as to operate with a second WSDL document, in accordance with a preferred embodiment of the present invention. Shown in FIG. 10 is a software application 1010 coded so as to use a web service corresponding to a WSDL document, WSDL #1. Using the present invention, software application 1010 is automatically adapted so as to use a web service 1020 corresponding to a WSDL document, WSDL #2. An input transformation 1030 transforms input conforming to WSDL #1 into corresponding input corresponding to WSDL #2. Similarly, an output transformation 1040 transforms output conforming to WSDL #1 into corresponding output conforming to WSDL #2. Together, transforms 1030 and 940 enable software application 1010 to run using web service 1040.

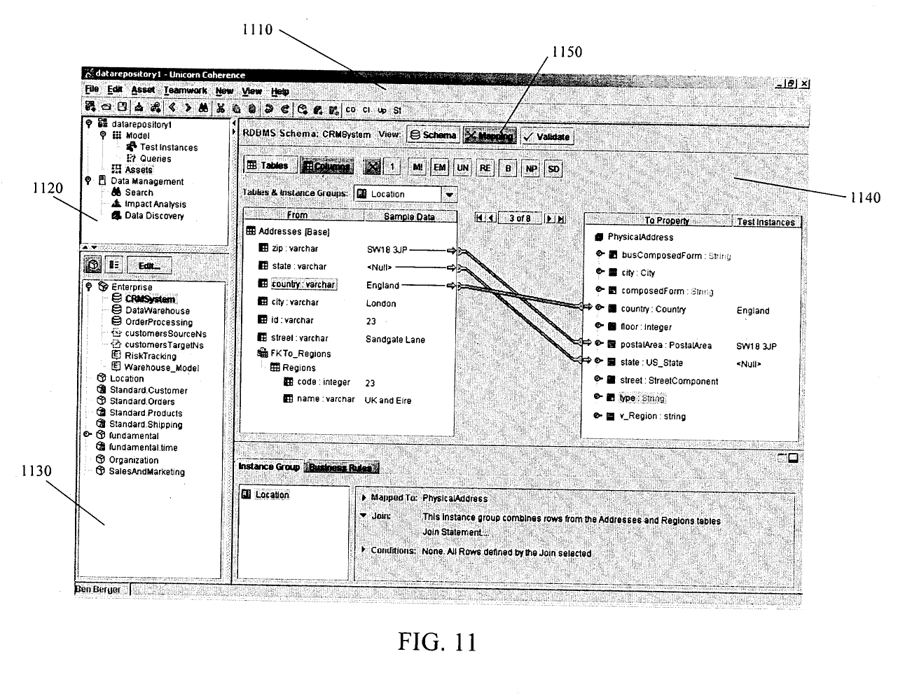

Reference is now made to FIG. 11, which is a sample user interface window 1110, in accordance with a preferred embodiment of the present invention. Shown in window 1110 is a frame 1120 with a hierarchical list for accessing enterprise data repositories and data management processing. Also shown in window 1110 is a frame 1130 with a hierarchical list for accessing components within a repository or process selected in frame 1110. Specifically, “Assets” is highlighted in frame 1120, and accordingly frame 1130 includes a list for accessing enterprise data assets. A relational database “CRMSystem” is shown highlighted in frame 1130. Data from CRMSystem is used to derive parameters for a web service.

Also shown in window 1110 is a frame 1140 with detailed information about the selected relational database CRMSystem. Specifically, a “Mapping” tab 1150 is selected, and frame 1140 displays mapping information for a mapping from a table named “Addresses” to a corresponding ontology class named “PhysicalAddress.” Frame 1140 enables a user to sequentially view rows of the Addresses table and corresponding instances of the class PhysicalAddress. As shown in frame 1140, the Addresses table contains a field “zip,” which corresponds to a property “postalArea” of class PhysicalAddress. The specific row displayed in frame 1140 contains “SW18 3JP” in its “zip” field, and likewise the specific instance displayed has “SW18 3JP” for its PhysicalAddress.postalArea property.

In reading the above description, persons skilled in the art will realize that there are many apparent variations that can be applied to the methods and systems described.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

[image]

[image]

[image]

[image]

[image]

[image]

[image]

[image]

[image]

[image]

What is claimed is:

1. A method for brokering between services, comprising:
providing a first and second service, each service having associated therewith a request and a response data structure; and
generating a transformation for producing data conforming to the request data structure for the second service, corresponding to data conforming to the response data structure for the first service.

2. The method of claim 1 wherein said generating a transformation is performed within a third service.

3. The method of claim 2 wherein the third service also executes the transformation, thus serving as a broker between the first and second services.

4. The method of claim 1 wherein the first and second services are web services, and wherein the request and response data structures are formatted as messages.

5. The method of claim 1 wherein the first and second services are remote procedure call (RPC) systems.

6. The method of claim 1 wherein the first and second services are remote function call (RFC) systems.

7. The method of claim 6 wherein the remote function call systems are Common Object Request Broker Architecture (CORBA) systems.

8. The method of claim 6 wherein the remote function call systems are remote method invocation (RMI) systems.

9. The method of claim 6 wherein the remote function call systems are Distributed Component Object Model (DCOM) systems.

10. The method of claim 6 wherein the remote function call systems are systems associated with enterprise information systems.

11. The method of claim 1 wherein said generating occurs within an application that uses the first and second service.

12. The method of claim 1 further comprising executing the transformation within an application that uses the first and second service.

13. The method of claim 1 further comprising mapping the request and response data structures of the first and second service into a common data model, and wherein said generating is based upon said mapping.

14. The method of claim 13 wherein the common data model is a common ontology model.

15. The method of claim 1 wherein the transformation is expressed using a Python programming language.

16. The method of claim 1 wherein the transformation is expressed using a Java programming language.

17. A method for developing applications comprising:
connecting designators for a first and second service within a layout diagram, each service having associated therewith a request and a response data structure; and
generating a transformation for producing data conforming to the request data structure for the second service, corresponding to data conforming to the response data structure for the first service.

18. The method of claim 17 further comprising mapping the request and response data structures of the first and second service into a common ontology model, and wherein said generating is based upon said mapping.

19. The method of claim 17 wherein the transformation is expressed using a Python programming language.

20. The method of claim 17 wherein the transformation is expressed using a Java programming language.

21. A method for developing applications comprising:
identifying connected designators for a first and second service within a layout diagram, each service having associated therewith a request and a response data structure; and
generating a transformation for producing data conforming to the request data structure for the second service, corresponding to data conforming to the response data structure for the first service.

22. The method of claim 21 further comprising mapping the request and response data structures of the first and second service into a common ontology model, and wherein said generating is based upon said mapping.

23. The method of claim 21 wherein the transformation is expressed using a programming language.

24. The method of claim 23 wherein the programming language is a Python programming language.

25. The method of claim 23 wherein the programming language is a Java programming language.

26. The method of claim 23 wherein the programming language is an XML programming language.

27. The method of claim 26 wherein the XML programming language is XSLT.

28. The method of claim 23 wherein the programming language is a Perl programming language.

29. The method of claim 23 wherein the programming language is a C++ programming language.

30. The method of claim 23 wherein the programming language is a Visual Basic programming language.

31. The method of claim 23 wherein the programming language is a Delphi programming language.

32. The method of claim 23 wherein the programming language is a C# programming language.

33. The method of claim 23 wherein the programming language is a Smalltalk programming language.

34. A method for registering services, comprising:
specifying at least one service having associated therewith at least one input and output data structure; and
mapping the at least one input and output structure into a common ontology model.

35. The method of claim 34 wherein the first and second services are web services, and wherein the request and response data structures are defined in a Web Services Description Language (WSDL) file.

36. The method of claim 34 wherein the first and second services are remote function call (RFC) systems.

37. The method of claim 36 wherein the remote function call systems are Common Object Request Broker Architecture (CORBA) systems, and wherein the request and response data structures are defined in an Interactive Data Language (IDL) file.

38. The method of claim 36 wherein the remote function call systems are remote method invocation (RMI) systems, and wherein the request and response data structures are defined in a Java interface.

39. The method of claim 36 wherein the remote function call systems are Distributed Component Object Model (DCOM) systems, and wherein the request ad response data structures are defined in a Microsoft Interface Definition Language (MIDL) file.

40. The method of claim 34 wherein the first and second services are web services, and wherein the request and response data structures are defined in a Universal Description Discovery and Integration (UDDI) registry.

41. The method of claim 34 wherein the first and second services are web services, and wherein the request and response data structures are defined in an Electronic Business Extensible Markup Language (ebXML) registry.

42. The method of claim 34 further comprising accessing the at least one web service within an application using a registry accessed through a Java API for XML (JAXR).

43. A method for providing semantic meaning to Java beans, comprising:
providing a plurality of Java beans, each Java bean having associated therewith a data structure; and
mapping the data structures of the plurality of Java beans into a common data model.

44. The method of claim 43 wherein the common data model is a common ontology model.

45. The method of claim 44 wherein said mapping comprises:
mapping a Java class into a corresponding ontology class; and
mapping a property of the Java class into a corresponding property of the ontology class.

46. The method of claim 43 further comprising translating semantically between two Java beans, using correspondences produced by said mapping.

47. A system for brokering between services, comprising:
an interface for executing a first and second service, each service having associated therewith a request and a response data structure; and
a transformation generator coupled to the interface, the transformation generator generating a transformation for producing data conforming to the request data structure for the second service, corresponding to data conforming to the response data structure for the first service.

48. The system of claim 47 wherein said transformation generator resides within a third service.

49. The system of claim 48 wherein the third service also executes the transformation, thus serving as a broker between the first and second services.

50. The system of claim 47 wherein the first and second services are web services, and wherein the request and response data structures are formatted as messages.

51. The system of claim 47 wherein the first and second services are remote procedure call (RPC) systems.

52. The system of claim 47 wherein the first and second services are remote function call (RFC) systems.

53. The system of claim 52 wherein the remote function call systems are Common Object Request Broker Architecture (CORBA) systems.

54. The system of claim 52 wherein the remote function call systems are remote method invocation (RMI) systems.

55. The system of claim 52 wherein the remote function call systems are Distributed Component Object Model (DCOM) systems.

56. The system of claim 52 wherein the remote function call systems are systems associated with enterprise information systems.

57. The system of claim 47 wherein said transformation generator is embedded within an application that uses the first and second service.

58. The system of claim 47 further comprising a run-time processor for executing the transformation within an application that uses the first and second service.

59. The system of claim 47 further comprising a data schema mapper for mapping the request and response data structures of the first and second service into a common data model, and wherein said transformation generator uses mappings derived by said data schema mapper.

60. The system of claim 59 wherein the common data model is a common ontology model.

61. The system of claim 47 wherein said transformation generator expresses the transformation using a Python programming language.

62. The system of claim 47 wherein said transformation generator expresses the transformation using a Java programming language.

63. A system for developing applications comprising:
a design tool for connecting designators for a first and second service within a layout diagram, each service having associated therewith a request and a response data structure; and
a transformation generator coupled to the design tool, the transformation generator generating a transformation for producing data conforming to the request data structure for the second service, corresponding to data conforming to the response data structure for the first service.

64. The system of claim 63 further comprising a data schema mapper for mapping the request and response data structures of the first and second service into a common ontology model, and wherein said transformation generator uses mappings derived by said data schema mapper.

65. The system of claim 63 wherein the transformation is expressed using a Python programming language.

66. The system of claim 63 wherein the transformation is expressed using a Java programming language.

67. A system for developing applications comprising:
a layout analyzer for identifying connected designators for a first and second service within a layout diagram, each service having associated therewith a request and a response data structure; and
a transformation generator coupled to the layout analyzer, the transformation generator generating a transformation for producing data conforming to the request data structure for the second service, corresponding to data conforming to the response data structure for the first service.

68. The system of claim 67 further comprising a data schema mapper for mapping the request and response data structures of the first and second service into a common ontology model, and wherein said transformation generator uses mappings derived by said data schema mapper.

69. The system of claim 67 wherein the transformation is expressed using a programming language.

70. The system of claim 69 wherein the programming language is a Python programming language.

71. The system of claim 69 wherein the programming language is a Java programming language.

72. The system of claim 69 wherein the programming language is an XML programming language.

73. The system of claim 72 wherein the XML programming language is XSLT.

74. The system of claim 69 wherein the programming language is a Perl programming language.

75. The system of claim 69 wherein the programming language is a C++ programming language.

76. The system of claim 69 wherein the programming language is a Visual Basic programming language.

77. The system of claim 69 wherein the programming language is a Delphi programming language.

78. The system of claim 69 wherein the programming language is a C# programming language.

79. The system of claim 69 wherein the programming language is a Smalltalk programming language.

80. A system for registering services, comprising:
a memory having data specifying at least one service having associated therewith at least one request and response data structure; and
a data schema mapper coupled to the memory, the data schema mapper mapping the at least one request and response structure into a common ontology model.

81. The system of claim 80 wherein the first and second services are web services, and wherein the request and response data structures are defined in a Web Services Description Language (WSDL) file.

82. The system of claim 80 wherein the first and second services are remote function call (RFC) systems.

83. The system of claim 82 wherein the remote function call systems are Common Object Request Broker Architecture (CORBA) systems, and wherein the request and response data structures are defined in an Interactive Data Language (IDL) file.

84. The system of claim 82 wherein the remote function call systems are remote method invocation (RMI) systems, and wherein the request ad response data structures are defined in a Java interface.

85. The system of claim 82 wherein the remote function call systems are Distributed Component Object Model (DCOM) systems, and wherein the request ad response data structures are defined in a Microsoft Interface Definition Language (MIDL) file.

86. The system of claim 80 wherein the first and second services are web services, and wherein the request and response data structures are defined in a Universal Description Discovery and Integration (UDDI) registry.

87. The system of claim 80 wherein the first and second services are web services, and wherein the request and response data structures are defined in an Electronic Business Extensible Markup Language (ebXML) registry.

88. The system of claim 80 further comprising accessing the at least one web service within an application using a registry accessed through a Java API for XML (JAXR).

89. A system for providing semantic meaning to Java beans, comprising:
a Java bean analyzer for analyzing a plurality of Java beans, each Java bean having associated therewith a data structure; and
a data schema mapper coupled to the Java bean analyzer, the data schema mapper mapping the data structures of the plurality of Java beans into a common data model.

90. The method of claim 89 wherein the common data model is a common ontology model.

91. The system of claim 90 wherein said data schema mapper maps a Java class into a corresponding ontology class, maps a property of the Java class into a corresponding property of the ontology class.

92. The system of claim 89 further comprising a semantic translator for translating between two Java beans, using correspondences produced by said data schema mapper.

93. A method for providing semantic meaning to web services descriptions, comprising:
providing a plurality of web services, each web service having associated therewith a request and a response data structure; and
mapping the request and response data structures of the plurality of web services into a common ontology model.

94. A system for providing semantic meaning to web services descriptions, comprising:
a web service analyzer for analyzing a plurality of web services, each web service having associated therewith a request and a response data structure; and
a data schema mapper coupled to the web service analyzer, the data schema mapper mapping the request and response data structures of the plurality of web services into a common ontology model.
